(19) United States
(12) Patent Application Publication
(10) Pub. No.: US 2026/0322649 A1
(43) Pub. Date: Oct. 15, 2026

(54) Method for Self Configuration of Differential Multidrop Networks

(71) Applicant: Bradford T. Hite, Valencia, CA (US)

(72) Inventor: Bradford T. Hite, Valencia, CA (US)

(21) Appl. No.: 19/179,990

(22) Filed: Apr. 15, 2025

(51) Int. Cl. H04L 12/40

(52) U.S. Cl. CPC H04L 12/4013

(57) ABSTRACT

A unique method whereby differential multidrop communications bus functions of slave device addressing and configuration information are automatically detected/processed by a network master is described. More specifically, the network master resolves slave device network addresses through a competitive process and configures each device from a database. Common applications based on such computer or instrumentation networks can benefit by no longer having to manually setup each slave device. The auto configuration method of the present invention is software based compatible with existing hardware platforms used to implement a multi-drop network. A detailed example is described for a MODBUS messaging implementation whereby broadcast commands are used to control the auto configuration process. In this example, multiple slave devices participate within a process to competitively assign addresses further allowing device specific configuration information to be retrieved from a database.

### CROSS-REFERENCES TO RELATED APPLICATIONS

Not Applicable.

### STATEMENT REGARDING FEDERALLY SPONSORED RESEARCH OR DEVELOPMENT

Not Applicable.

### REFERENCE APPENDICES

Not Applicable

### BACKGROUND OF THE INVENTION

### 1. Field of the Invention

This invention relates to the field of computer based serial data communication bus multidrop networks. Specifically, a communications network configured as a multidrop topology whereby multiple stations are connected via a differential signaling bus. Multidrop networks currently require each station to contain a unique network identifier or address manually assigned during configuration. The present invention provides a method of self or automatic configuration for network identifiers based on existing hardware platform capabilities. A software based auto configuration mode is described wherein network stations participate in a competitive initialization process to resolve and assign network identifiers.

### 2. Description of the Related Art

Some of the most widely used serial data communication differential bus topologies found today consist of RS-485, RS-422, CAN, AIRINC-429, M-LVDS and Ethernet (SPE) multidrop configurations. Multiple applications where this bus type is used includes: industrial automation & control, building automation, video surveillance, point-of-sale systems, traffic control and data acquisition. These bus configurations offers a maximum of 20 Mbps data rates, transmission distances of over 1200 meters (3900 feet) and utilize differential signaling offering high noise immunity. The electrical layout of a RS-485 multidrop network is shown in reference FIG. 1 for a three station configuration. RS-485 multidrop operates in a half duplex mode supporting only one way transmission between a single pair of network stations. The electrical layout of a RS422 multi-drop network is shown in reference FIG. 2 for a three station configuration. RS422 multi-drop operates in a full duplex mode supporting two way transmissions between a single pair of network stations. Typically, a host computer controlled network master station supervises data transfers with slave network stations using a request/response methodology. Each slave station will continually monitor bus traffic until a request is issued to its specific network identifier causing the addressed slave to respond. In this manner, the master station can communicate independently with each slave station for data transfer operations.

One problem aspect of differential multi-drop networks is the condition whereby all network stations reside in an idle mode causing the network signals to float. Floating is a condition where all stations are disabled from electrically driving the network differential signals causing an indeterminate logic state. Two of the most common methods used to eliminate this condition are fail-safe mode bias resistors or compensation within the differential receiver circuit. Pull up/down bias resistors are applied to the bus signals effectively causing a positive differential voltage during a non driven bus state. Similarly, on chip compensation can be built into the differential receiver circuit to produce a known logic output for a zero differential bias input condition. In either of these cases, the receiver inputs are biased to produce a logic high output when the differential signals are floating. The present invention takes advantage using this property of a floating high logic output state combined with the logical AND of bus driven low logic states to support a self configuration mode.

An alternate pseudo multi-drop configuration providing an different auto configuration capability is an Ethernet based type referred to as MODBUS TCP. This TCP/IP based configuration replaces the standard MODBUS network identifier with the Network Interface Card (NIC) address for each station. Unique NIC addresses are assigned by the equipment manufacturer and are embedded within the device firmware. A MODBUS TCP/IP configuration using Ethernet is typically capable of transmitting data up to a 100 MHz rate over maximum distance of 100 meters. Ethernet being a peer/peer network provides a pseudo hardware multi-drop capability emulated by network control software.

Automatic system configuration has been addressed in the prior art for differing levels of component integration. Divjak in U.S. Pat. No. 5,444,644 (22 Aug. 1995) titled “Auto-Configured Instrumentation Interface” describes a system with capability to identify different type of input/output sensor devices connected to its inputs. The input devices are described as physical sensor types for example a RTD, Pressure sensor or Potentiometer. In this implementation, a processor performs a systematic analysis by stimulating the input device to determine the sensor type and capability. This configuration is limited to automatic configuration for input device (sensor) types supported by the interface circuitry and not the input interface itself. Several more recent patents cite this reference but are limited to the same concept of sensor input device automatic configuration.

The next level of component integration addressed in prior art is a self contained input/output interface function coupled between the controlling module and physical sensor. Matsuura in U.S. Pat. No. 6,301,508 (9 Oct. 2001) titled “Automatic Instrumentation System” describes a system of controller and instrument modules connected by a communication line link. The controller module queries each instrument module over the communication link and receives a unique executable control program for module interfacing. These control programs are stored on a memory within each individual instrumentation module allowing the controller to perform an automatic system configuration. This method of configuration is analogous to the method described above whereby each interface module contains configuration information accessed by the control module. Slattery et al in U.S. Pat. No. 10,181,853 (15 Jan. 2019) titled “Configurable Hardware Platform for Measurement or Control” describes a system whereby a control circuit receives configuration information from an interface circuit used to configure the interface circuit. The configuration information is described as a “table” or “information stored in registers or a memory”. Configuration information received by the control circuit contains detailed modes/capabilities supported by the interface circuit thereby requiring a more complicated table or file data structure. Paz Lopez et al in US 2014/0148952 (29 May 2014) titled “Central Node and Terminal Instrumentation Node for Self-Configuring and Secure Building Automation System” describes a distributed network concept whereby instrumentation nodes auto configure with a central control node when added to the system. The automatic configuration steps comprise: 1) an instrumentation node sending unsolicited configuration information to the control note, 2) the control node adding the instrumentation node into the network configuration database, and 3) the control node sending control software to the instrumentation node if required. All of these prior art systems described above teach a method whereby configuration information is transferred from a remote network interface module to a control module. The present invention offers a simplification of the remote network module design eliminating any software or processor hardware necessary to support transfer of embedded configuration data or code.

### BRIEF SUMMARY OF THE INVENTION

The present invention comprises a method whereby differential multi-drop communications bus functions of slave device addressing and configuration information are automatically detected/processed by a network master. Common applications based on such computer or instrumentation networks can benefit by no longer having to manually setup each slave device. Further, the addition of slave devices to the bus network requires only re-running of the auto configuration process. The self configuration method of the present invention is software based compatible with existing hardware platforms used to implement a multidrop network. A detailed example is described for a MODBUS messaging implementation whereby broadcast commands are used to control the auto configuration process. In this example, multiple slave devices participate within a process to competitively assign addresses further allowing device specific configuration information to be retrieved from a database. The database configuration information can be sent to the associated slave device and optionally be loaded internally to a network master.

### BRIEF DESCRIPTION OF THE DRAWINGS

FIG. 1 is a reference block diagram for a RS-485 multidrop network.

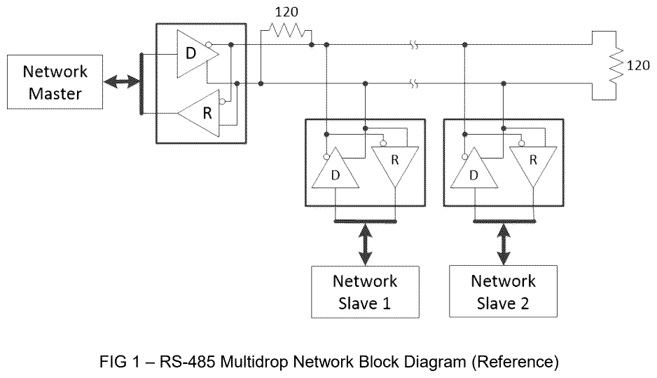

FIG. 2 is a reference block diagram for a RS-422 multidrop network.

FIG. 3 is an example schematic diagram for the present invention.

FIG. 4 is an example flow chart detailing the process steps taken by the present invention to configure a multidrop network.

FIG. 5 is an example block diagram for an AC coupled differential multidrop network.

### REFERENCE NUMERALS IN THE DRAWINGS

| | | | |
|---|---|---|---|
| 300 | Host Computer or | 302 | Control Software |
| | Network Master | | Executing on Host |
| | Device | | Computer |
| 304 | Database | 306 | Host Computer Control |
| | | | Interface |
| 308 | Multidrop Interface | 310 | Transmitter Enable |
| | Circuit | | Signal |
| 312 | Fail-Safe Pull Down | 314 | Fail-Safe Pull Up |
| | Resistor | | Resistor |
| 316 | Transmitter Enable | 318 | Network Device |
| | Signal | | Control Interface |
| 320 | Network Slave | 322 | Transmitter Enable |
| | Device | | Signal |
| 324 | Network Device | 326 | Network Slave Device |
| | Control Interface | | |
| 328 | Transmitter Enable | 330 | Multidrop Interface |
| | Signal | | Circuit |
| 332 | Network Device | 334 | Network Slave Device |
| | Control Interface | | |
| 336 | Identification | 338 | Identification |
| | Information | | Information Memory |
| | Memory | | |
| 340 | Identification | 342 | Multidrop Network |
| | Information | | Differential Positive |
| | Memory | | Signal |
| 344 | Multidrop Network | 346 | Multidrop Interface |
| | Differential | | Circuit |
| | Negative Signal | | |
| 348 | Multidrop Interface | 350 | Configuration |
| | Circuit | | Information |
| 400 | Process Step to | 402 | Process Step for |
| | Set Host Computer | | Network Master to |
| | and all Network | | Send Configuration |
| | Devices to | | Mode Start |
| | MODBUS Inactive | | |
| 404 | Process Step for all | 406 | Process Step for all |
| | Network Device(s) | | Slave Device(s) to |
| | to Initialize | | Read Internal |
| | MODBUS Data to | | Identification |
| | Low (“0”) State with | | Information Memory as |
| | Transmitter | | S/N |
| | Disabled | | |
| 408 | Process Step for all | 410 | Process Step for |
| | Network Device(s) | | Network Master |
| | to Reset S/N Bit | | Sending Synch Pulse |
| | Counter | | on MODBUS |
| 412 | Process Step for all | 414 | Process Step for |
| | Slave Device(s) | | Network Master |
| | Writing S/N Bit[n] | | Sending Synch Pulse |
| | onto MODBUS | | on MODBUS |
| 416 | Process Step for | 418 | Process Step for |
| | Slave Device(s) | | Network Master |
| | Writing Compliment | | Sending Synch Pulse |
| | S/N Bit[n] onto | | on MODBUS |
| | MODBUS | | |
| 420 | Process Step for | 422 | Process Step for Slave |
| | Network Master | | Devices(s) Comparing |
| | Writing Detected | | Master Detected Bit[n] |
| | BIT[n] onto | | to S/N Bit[n] |
| | MODBUS | | |
| 424 | Process Step for a | 426 | Decision Step for Slave |
| | Slave Device(s) to | | Device(s) Comparing |
| | Terminate | | Bit(s) |
| | Configuration Mode | | |
| | Activity and Enter | | |
| | Idle State | | |
| 428 | Decision Step for | 430 | Process Step for |
| | Remaining | | Remaining Device |
| | Device(s) | | Staying in Active Mode |
| | Determining Last | | |
| | S/N Bit | | |
| 432 | Process Step for | 434 | Process Step for |
| | Network Master | | Network Master |
| | Setting the | | Accessing Database |
| | Remaining Device | | Info using Remaining |
| | Address | | Device S/N |
| 436 | Process Step for | 438 | Process Step for |
| | Network Master | | Configured Device |
| | Configuring | | Entering Normal State |
| | Remaining Device | | Terminating |
| | with Database Info | | Participation in any Up- |
| | | | Coming Configuration |
| | | | Mode Activity |
| 440 | Decision Step for | 442 | Process Step for |
| | Network Master | | Network Device(s) |
| | Determining all | | Incrementing S/N Bit |
| | Network Device(s) | | Counter |
| | are Configured | | |

### DETAILED DESCRIPTION OF THE INVENTION

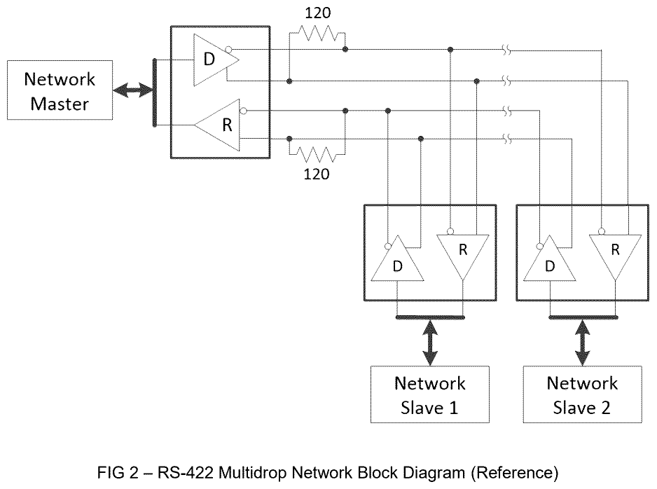

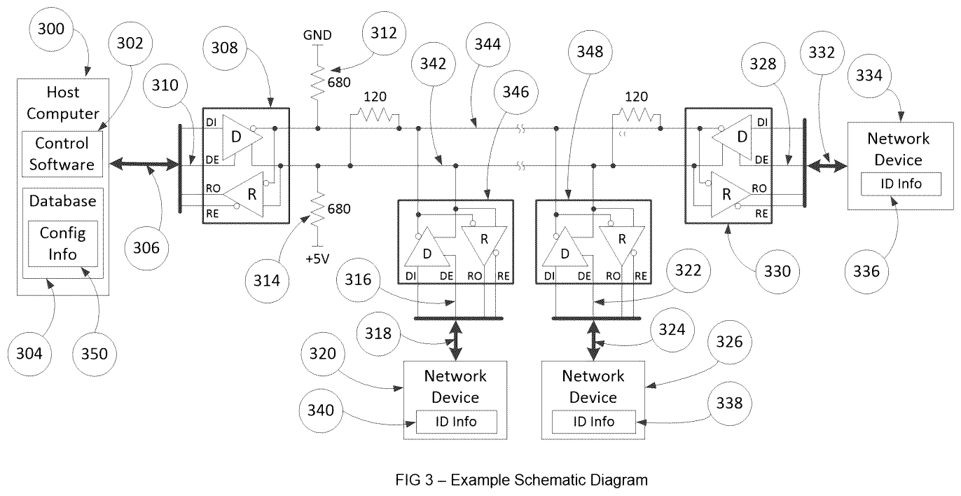

An example schematic diagram for the preferred embodiment of the present invention is shown in FIG. 3 as a general RS-485 network based on differential signaling. Although this example is based on RS-485, the same discussion pertains to rearrangement of the circuit components as a general RS-422 network per FIG. 2. Network Master Device (Host Computer) 300 is configured to execute a Control Software 302 used to interface with Control Interface 306 and Database 304. Control Interface 306 provides data communications between the Network Master Device 300 and Multidrop Interface Circuit 308. Some example integrated circuits supporting multidrop differential implementations of Interface Circuit 308 can include but are not limited to Texas Instruments THVD1520 (Half Duplex), Analog Devices MAX33049E (Full Duplex) and Analog Devices ADM485E (Half Duplex). Within Control Interface 306, the Transmitter Enable Signal 310 is used to enable/disable Multidrop Interface Circuit 308 from driving the network connections Positive Differential Signal 342 and Negative Differential Signal 344. Database 304 contains Configuration Information 350 used to initialize each network slave device. Examples of Configuration Information 350 can include but are not limited to Firmware, Software or Parameter type data. Optional fail-safe bias resistors 312 and 314 can be used to provide a floating bus logic high state on each station's differential receiver input. These bias resistors are only required in the case where differential receiver circuits are used not containing a built-in fail-safe input circuit feature. Network Slave Device 320 interfaces with Control Interface 318 and internal Identification Information Memory 340. Control Interface 318 provides data communications between the Network Device 320 and Multidrop Interface Circuit 346. Within Control Interface 318, the Transmitter Enable Signal 316 is used to enable/disable Multidrop Interface Circuit 346 from driving the network connections Positive Differential Signal 342 and Negative Differential Signal 344. Identification Information (ID Info) Memory 340 contains unique network identification information accessible by Slave Device 320. Examples of identification information can include but are not limited to a binary code or an ASCII string. Network Slave Device 326 interfaces with Control Interface 324 and internal Identification Information Memory 338. Control Interface 324 provides data communications between the Slave Device 326 and Multidrop Interface Circuit 348. Within Control Interface 324, the Transmitter Enable Signal 322 is used to enable/disable Multidrop Interface Circuit 348 from driving the network connections Positive Differential Signal 342 and Negative Differential Signal 344. Identification Information Memory 338 contains unique network identification information accessible by Slave Device 326. Network Slave Device 334 interfaces with Control Interface 332 and internal Identification Information Memory 336. Control Interface 332 provides data communications between the Slave Device 334 and Multidrop Interface Circuit 330. Within Control Interface 332, the Transmitter Enable Signal 328 is used to enable/disable Multidrop Interface Circuit 330 from driving the network connections Positive Differential Signal 342 and Negative Differential Signal 344. Identification Information Memory 336 contains unique network identification information accessible by Slave Device 334. During the self or auto configuration process, Configuration Information 350 will be loaded into each Slave Network Device 320, 326 and 334 by Network Master 300. Network Master 300 accesses Slave Devices 320, 326 and 334 by obtaining or resolving the Identification Information 340, 338 and 336 respectively using a competitive request/response process. Control Software 302 can then use the identification information to access Database 304 in order to retrieve associated Configuration Information 350. Configuration Information 350 can then be loaded into each Slave Device to complete the system auto configuration process. The present invention supports automatic configuration with minimal hardware since only identification information is sent from each slave to the host computer.

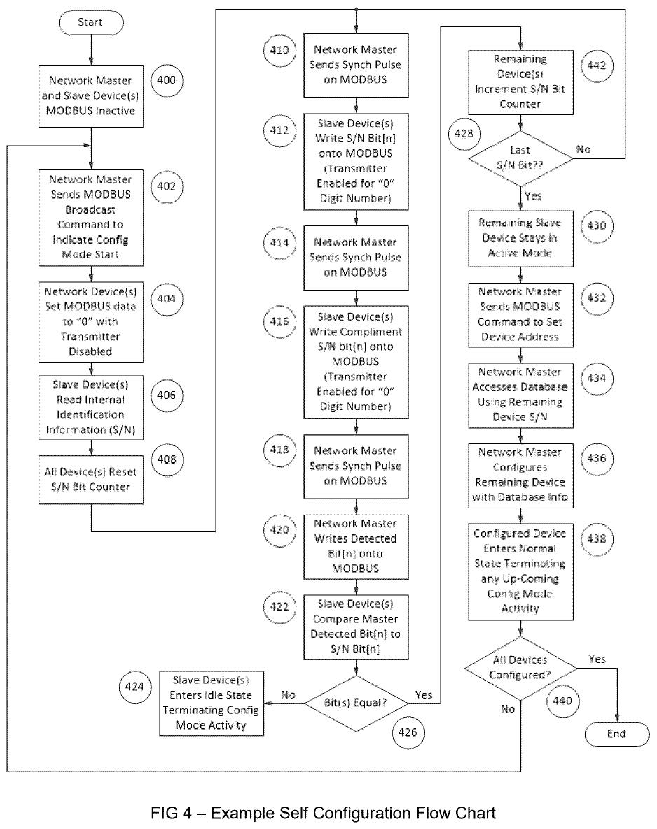

FIG. 4 shows an example flow chart of the process steps used by the present invention for self or auto configuration of the differential multi-drop network slave devices by a network master (host computer). This example process is based on a MODBUS implementation whereby each network slave device is assigned a network master derived device (unit) address. Initially, Network Master 300 and Network Slave Devices 320, 326 and 334 will startup in an idle state with the MODBUS floating per step 400. Step 402 is performed next whereby the network master sends a broadcast message received by all slave devices to initiate Auto Configuration Mode start. Upon receiving the broadcast message, all slave devices will configure their Control Interface 318, 324 and 332 by setting the MODBUS data to “0” and disabling the transmitter in step 404. Disabling of the transmitter is accomplished by setting Transmitter Enable Signal(s) 316, 322 and 328 to logic low. Following in step 406, each slave device will read its own unique manufacturer assigned identification information or serial number (S/N). After S/N reading, all network devices will reset their internal S/N bit counter in step 408. The S/N bit counter is used by each network device to synchronize bit transfers across the MODBUS. Next in step 410, the network master sends a synchronization pulse onto the MODBUS. In response to this synchronization pulse, each slave device will write its first S/N bit onto the MODBUS per step 412. Slave devices will enable their transmitter for a “0” value S/N bit or leave the transmitter disabled for a “1” S/N bit. Since the MODBUS (designed to be fail safe) is floating (non-driven) a high logic level will be detected by the network master if no slave device has enabled its transmitter. Otherwise, if one or more slave devices enable their transmitter, a logic low level will be detected by the network master. Next in step 414, the network master will again send a synchronization pulse. In response per step 416, each slave device will write the complement of its first S/N bit onto the MODBUS. The network master has now received the multi-slave logical AND of both true and complement versions of the first S/N bit. These two values allow the network master to determine one of four states for the multi-slave responding devices: 1) both 0s/1s are present, 2) only 0s, 3) only 1s, 4) no slave response. Next in step 418, the network master will again send a synchronization pulse. In response per step 420, the network master will write its detected bit onto the MODBUS for reading by all slave devices. Slave devices will now compare the network master detected bit with their own S/N bit per step 426. If the bit values are equal then the slave device will continue participating in the auto configuration mode. Otherwise, the slave device will enter an idle state terminating its auto configuration activity per step 424. The network master and remaining slave devices participating in the auto configuration mode will now increment the their S/N bit counters to point at or access the next S/N bit per step 442. Next, a S/N bit counter max value check is made in step 428. If the last S/N bit has been processed the loop is stopped leaving a single remaining slave device participating in the auto configuration mode. This single remaining slave device has successfully completed the competitive identification information resolving process. Otherwise, processing continues at step 410 with the next S/N bit. Upon the loop termination step 430, the remaining slave device continues in an active state communicating with the network master. The network master will issue a unique device address to the slave device for further network communications in step 432. Next in step 434, the network master (host computer) can access database 304 based on the slave device S/N to retrieve configuration information 350. At this point the network master can configure the slave device by loading configuration information 350 along with configuring any needed internal device specific information in step 436. Finally in step 438, the now configured slave device will enter a normal state and will not participate in follow-on auto configuration mode operations necessary to configure remaining slave devices idled during this auto configuration mode per step 424. Step 440 is a check by the network master to determine if all slave devices have been configured and thereby operating in normal state. If slave devices remain to be configured a new auto configuration mode will be initialed per step 402. Otherwise all network slave devices have been configured allowing full network data communication to proceed.

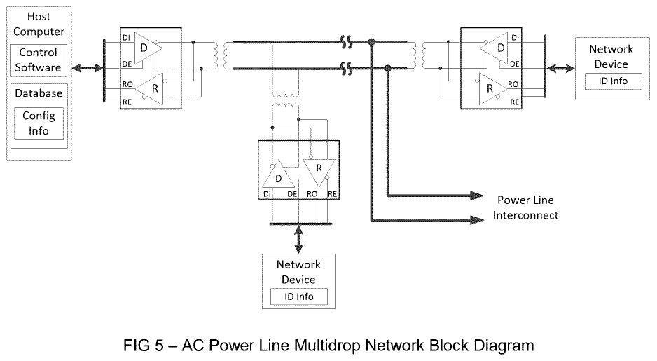

An alternate embodiment of the present invention is shown in FIG. 5 as a differential AC coupled power line multidrop network. Power line communications are used in both residential and industrial applications for information exchange between network stations. Differential AC coupling between a network station and the power line interconnect can be achieved by several methods. FIG. 5 shows an example transformer coupled implementation whereby each network station is coupled by a balun. Other examples can include but are not limited to capacitive or optical isolator coupling. In these systems being AC coupled, the electrical signaling is typically based on amplitude or frequency modulated waveforms driven onto the power line. This method of operation requires a redefinition of the high and low logic states described above to be in terms of AC waveforms. With reference to the description of FIG. 3 and FIG. 4, each slave device will initially setup their transmitter to generate a waveform representing a low logic state with output disabled. Slave devices will enable their transmitter for a “0” value S/N bit or leave the transmitter disabled for a “1” S/N bit. Since the power line interconnects are normally floating (non-driven) a high logic level will be detected by the network master if no slave device has enabled its transmitter. Otherwise, if one or more slave devices enable their transmitter, a logic low level will be detected by the network master. Given this redefinition of the logic states, all other aspects of the auto configuration mode operation remain unchanged.

One further alternate embodiment of the present invention can utilize the AC waveforms described above being transferred via an optical fiber network. In this embodiment, the electrical signal transmitter, receiver and transformer for each station shown in FIG. 5 is replaced by an optical transceiver circuit. Although optical signaling is not considered differential, the remaining aspects of the invention remain unchanged for implementation of an auto configuration mode.

The claimed invention is:

1. A self configuring differential multidrop network comprising:
a. a network master executing control software;
b. at least two network slave devices coupled to the network master;
c. a first slave device generating first identification information in response to the network master;
d. a second slave device generating second identification information in response to the network master;
e. wherein the network master is configured to resolve the first identification information of the first slave device using a competitive process; and
f. wherein the network master is configured to resolve the second identification information of the second slave device using the competitive process.

2. The system of claim 1, wherein the network master is configured to retrieve first configuration information from a database based on the first identification information and load the first configuration information into the first slave device.

3. The system of claim 2, wherein the network master is configured to retrieve second configuration information from the database based on the second identification information and load the second configuration information into the second slave device.

4. A method of differential multidrop network self configuration comprising:
a. executing control software on a network master;
b. generating first identification information by a first network slave device in response to the network master;
c. resolving the first identification information of the first network slave device by the network master using a competitive process;
d. generating second identification information by a second network slave device in response to the network master; and
e. resolving the second identification information of the second network slave device by the network master using the competitive process.

5. The method of claim 4, further comprising:
a. retrieving first configuration information from a database based on the first identification information; and
b. loading the first configuration information into the first network slave device.

6. The method of claim 5, further comprising:
a. retrieving second configuration information from the database based on the second identification information; and
b. loading the second configuration information into the second network slave device.

7. A self configuring optical multidrop network comprising:
a. An optical network master executing control software;
b. at least two optical network slave devices coupled to the network master;
c. a first slave device generating first identification information in response to the network master;
d. a second slave device generating second identification information in response to the network master;
e. wherein the network master is configured to resolve the first identification information of the first slave device using a competitive process; and
f. wherein the network master is configured to resolve the second identification information of the second slave device using the competitive process.

8. The system of claim 7, wherein the network master is configured to retrieve first configuration information from a database based on the first identification information and load the first configuration information into the first slave device.

9. The system of claim 8, wherein the network master is configured to retrieve second configuration information from the database based on the second identification information and load the second configuration information into the second slave device.
